(19) United States
(12) Patent Application Publication
(10) Pub. No.: US 2005/0199655 A1
(43) Pub. Date: Sep. 15, 2005

(54) Dispenser-applicator typically with massage head

(76) Inventor: Robert Petit, Cluny (FR)

Correspondence Address: YOUNG & THOMPSON, 745 SOUTH 23RD STREET, 2ND FLOOR, ARLINGTON, VA, 22202, US

(21) Appl. No.: 11/062,928

(22) Filed: Feb. 23, 2005

(30) Foreign Application Priority Data
Feb. 26, 2004 (FR) 04 01955

(51) Int. Cl. B67D 3/00; B65D 47/00

(52) U.S. Cl. 222/546

(57) ABSTRACT

The dispenser-applicator includes a receptacle formed from a body and a distribution head having at least one orifice, and a cap that will close the head by screwing. The orifice includes a single orifice or a plurality of n orifices, not having any symmetry of revolution. The cap includes an outer shell carrying an internal thread and an inner sealing insert free to move in rotation with respect to the outer shell. The inner insert has a bottom carrying an axial projection capable of closing off the single orifice; the insert and the head cooperate during the screwing due to an orientation element, so as to automatically orient the insert with respect to the head so that the axial projection faces the orifice and closes it off.

### DOMAIN OF THE INVENTION

The invention relates to the domain of fluid product dispensers, typically for products in the form of pastes, creams, oils or powder products.

It also relates to the domain of dispensers including a so-called distribution head for application of the said product on a support, typically the skin.

Finally, it relates to the domain of dispenser closing systems.

### STATE OF THE ART

A large number of dispensers-applicators for fluid or powder products are already known.

Thus, French patent FR 2 820 958 issued by the applicant describes a ball dispenser-applicator for fluid cosmetic products.

Similarly, French application No. 02 12613 describes a digital paste cosmetic product dispenser with a head comprising a plurality of orifices, and a closing cap.

Problems that Arise

In general, the dispenser head comprises a circular central orifice that is not adapted or is poorly adapted to direct application of the product on the skin in the case of cosmetic or dermatological product, or onto any other support in the case of another product. In this case, the palm of the hands or the fingers is used as an application means, with the corresponding disadvantages, particularly in terms of hygiene and cleanliness.

However, the dispenser head may include a plurality of orifices, or a non-circular orifice. In this case, the dispenser head as a whole is closed by a cap. Consequently, since the said orifices are not closed individually, the result may be variable and continuous product losses or dirt collecting on the outside surface of the said head, depending on the nature of the packaged product. Furthermore, it may be difficult to obtain a sealed closure, except by applying strong manual closing and opening movements beyond what is currently accepted as being a normal force for the user.

Finally, there may be a problem of progressive blocking of the said orifices, depending on the nature of the product packaged in the said dispenser.

Thus, dispenser heads are rarely adapted to direct and efficient application of the said product, particularly because orifices with a shape adapted to such an application would be difficult or inconvenient to close in a sealed manner.

The subject of the invention is a dispenser-applicator for which the head may include at least one arbitrary shaped orifice, namely typically a non-circular orifice, possibly non-centred with respect to the axial screwing direction.

In particular, this head may be adapted to an application of the said product typically with a particular distribution of the said product and/or massage of the said support during application of the said product, typically massage of the skin, the said orifice being closable by a cap by simple screwing, although in this case the said orifice is not a traditional orifice, namely a single circular orifice centred along the axial direction of the said screwing.

### DESCRIPTION OF THE INVENTION

According to the invention, the dispenser-applicator of a fluid or powder product, typically a cosmetic product onto a support, typically the skin, comprises a receptacle that will contain the said product, formed from a body and a threaded distribution head provided with at least one orifice, and a threaded cap that will close the said head, the said cap typically comprising an internal thread and the said head typically comprising an external thread, the said internal and external threads cooperating such that the said cap can close the said head by screwing along an axial screwing direction. This dispenser-applicator is characterised in that:
a) the said orifice forms or comprises a single orifice or n orifices, the said single orifice or the said n orifices not having any symmetry of revolution with respect to the said axial direction,
b) the said cap comprises an outer shell carrying the said internal thread and an inner sealing insert, the said insert being free to move in rotation along the said axial direction with respect to the said outer shell,
c) the said inner insert comprises a bottom carrying an axial projection forming a single axial projection capable of closing off the said single orifice, or n axial projections capable of closing off the said n orifices, the said single axial projection or the said n axial projections typically forming a sealing pin or n sealing pins, the said sealing pin or the said n sealing pins having a section matching the section of the said single orifice or the said n orifices, such that the said sealing pin or the said n sealing pins are capable of closing off the said single orifice or the said n orifices, typically by axial penetration at the end of screwing,
d) the said insert and the said head cooperate during the said screwing due to an orientation means, firstly so as to automatically orient the said insert with respect to the said head during screwing of the said cap onto the said head by relative manual rotation of the said outer shell with respect to the said receptacle, so that the said single axial projection or the said n axial projections face the said single orifice or the said n orifices, then typically displacing the said axial insert with respect to the said head in order to close off the said orifice.

Thus, due to this combination of means a) to d), a simple screwing of the cap closes off the said orifice, or individually closes off each of the orifices of the said head regardless of their position, shape or number on the said head, so that the head can be kept clean and the risk of product losses is limited.

Therefore, the invention provides a means of choosing different orifice shapes to enable direct application of the product on the skin or the face in the case of cosmetic products or dermatological care, or any type of support when the product is another product, for example such as glue, an adhesive, without the problem of closing off the said orifice or orifices limiting the possible shapes.

The fact that the axial projection closes off the said orifice each time that it is screwed in, typically by axial penetration of the lower end of the said axial projection into the said orifice, that the said orifice is in the form of a single orifice or a plurality of orifices, can prevent progressive blocking of the said orifice with time, which can occur with some types of products, for example such as products that tend to dry or harden in contact with air.

### List of Figures

All figures relate to the invention.

FIG. 1a is a partial perspective view of a dispenser-applicator (1).

FIG. 1b is an axial sectional view along the axial direction (10) of the said cap (5) and the said distribution head (4).

FIG. 1c is an enlarged partial view of FIG. 1b.

FIG. 1d is a bottom view of the said assembly (9).

FIGS. 2a and 2b are similar to FIG. 1a, after the said cap (5) has been unscrewed from the said head (4, 4″).

FIG. 2a is a perspective top view of the said cap (5) and its outer shell (6).

FIG. 2b is a perspective top view of the said head (4, 4″) fixed to a portion of the body (3) of the receptacle (2).

FIGS. 3a and 3b are views showing the said dispenser-applicator (1), in a partial axial section similar to that shown in FIG. 1c.

FIG. 3a corresponds to the embodiment in FIG. 1c in which the said distribution head (4) forms an independent part (4″) separate from the body (3).

FIG. 3b corresponds to another embodiment in which the said distribution head (4) forms a single piece part (4′) with the body (3), this assembly typically forming a tube open at its bottom so that it can be filled.

FIGS. 4a and 4b illustrate the different parts forming the dispenser-applicator (1) in FIG. 1a separate from each other and including, from the top and working downwards, the shell (6), the inner insert (7), the distribution head (4, 4″), the upper portion of the tube body (3) including a shoulder and a central neck (30).

FIG. 4a is a perspective view of the bottom and one side, while FIG. 4b corresponds to a perspective view of the top and one side.

FIG. 5 diagrammatically shows 20 different variants of the orifice (41) marked from A to T, in the form of a single orifice (42) or a plurality of orifices (43), and the corresponding axial projection variants (71) that close off the said orifice (41) in the form of a single axial projection (72) or a plurality of axial projections (73).

FIGS. 6a and 6b represent different embodiments of the orientation means (8), through diagrammatic side views of the male elements (80) and female elements (81) that cooperate during screwing of the said cap (5) onto the distribution head (4).

In FIG. 6a, as in FIG. 2b, the skirt (46) of the distribution head (4) supports the female element (81) in the form of three adjacent ramps with a “V-shaped” profile (810).

FIG. 6b shows the reverse case to the above; the inner insert (7) of the cap (5) carries the female element (81) in the form of 3 adjacent ramps with a “V-shaped” profile (810), while the skirt (46) supports 3 axial projections (71) forming the male axial element (8).

FIGS. 7a to 7c show a diagrammatic view of the head (4) of FIG. 6a.

FIG. 7a shows the case of symmetry of rotation S₁.

FIG. 7b shows the case of symmetry of rotation S₂.

FIG. 7c shows the case of symmetry of rotation S₄.

FIGS. 8a to 8d show axial sections illustrating different embodiments of closing off the orifice (41, 42, 43, 430) by the said axial projection (71, 72, 73, 730).

### DETAILED DESCRIPTION OF THE INVENTION

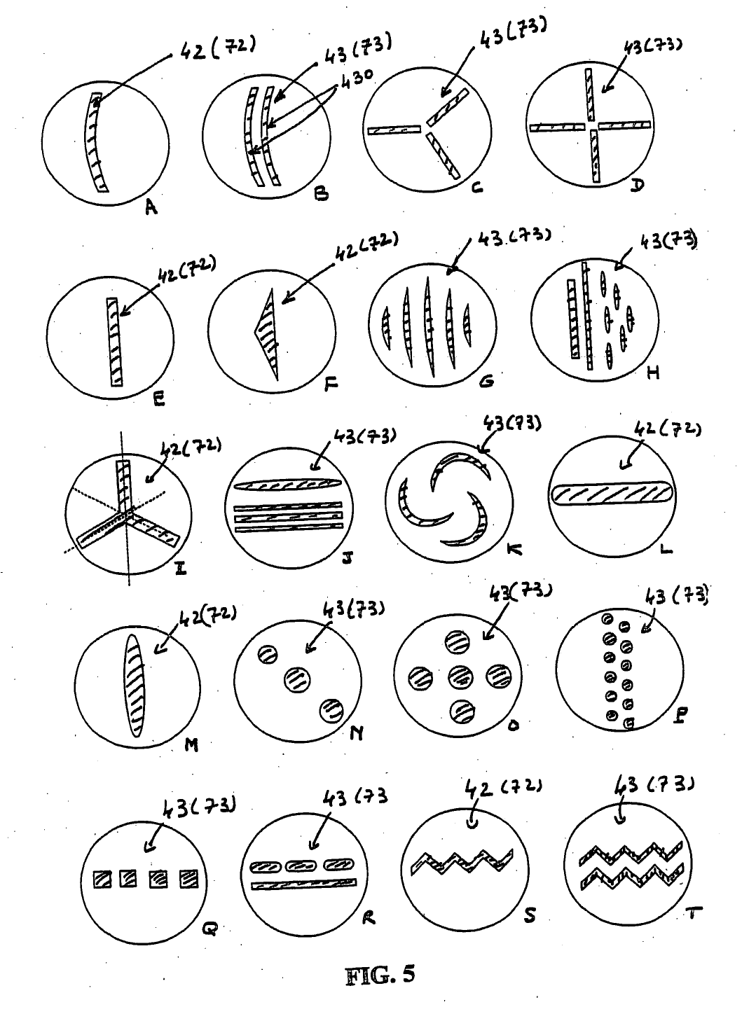

According to one embodiment of the invention, the said orifice (41) may be composed of the said single orifice (42). As shown on the variants A, E, F, I, L, M and S in FIG. 5, this single orifice may have a very wide variety of shapes.

According to another embodiment of the invention, the said orifice (41) may be composed of the said n orifices (43), where n varies from 2 to 12.

As shown in FIG. 5, the number of n orifices is equal to:
2 for variants B and T,
3 for variants C, K and N,
4 for variants D, J, Q and R,
5 for variant G,
8 for variant H,
12 for variant P.

The number n may be chosen as a function of the required effect during application of the product, possibly depending on the viscosity of the product to be applied.

According to the invention, the said single orifice (42) or the said n orifices (43) may have a symmetry of rotation S_{N} with respect to the said axial screwing direction (10), where N typically varies from 1 to 8, a symmetry of rotation S_{N} denoting identity of the object by rotation of 360°/N.

A symmetry S₁ corresponds to the case in which the orifice (41) is arbitrary and does not have its own symmetry since a rotation of 360° is necessary to obtain the initial configuration. Examples of variants with order 1 symmetry S₁ are A, B, F, G, H, J, P, R and T as shown in FIG. 5.

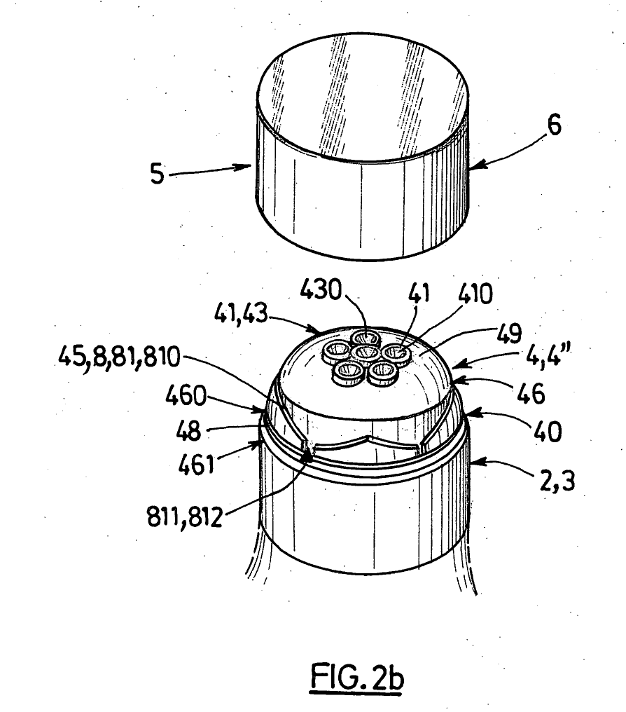

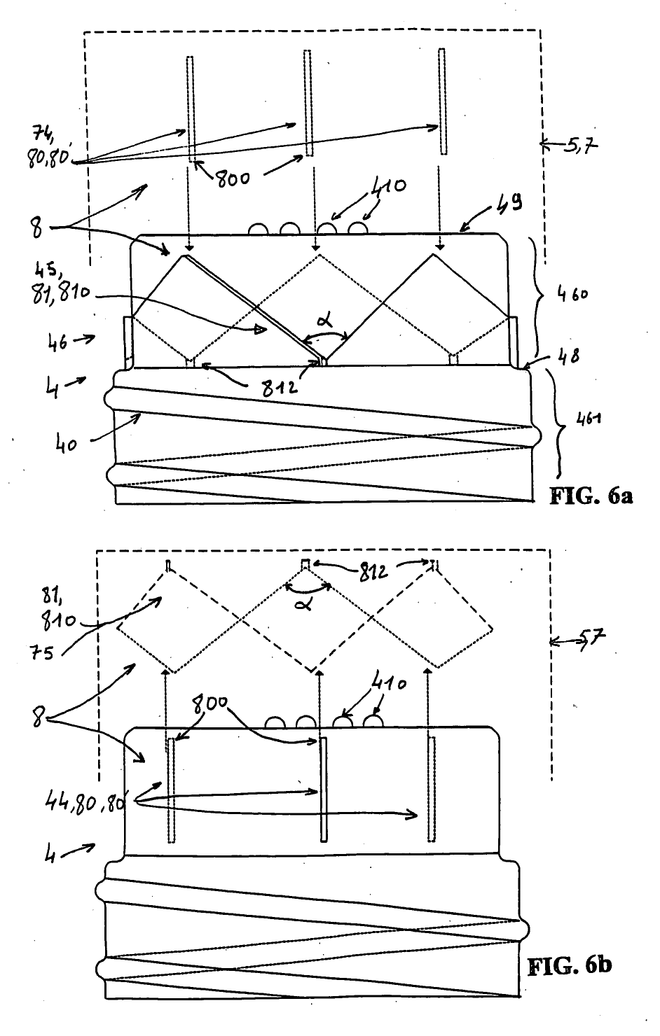

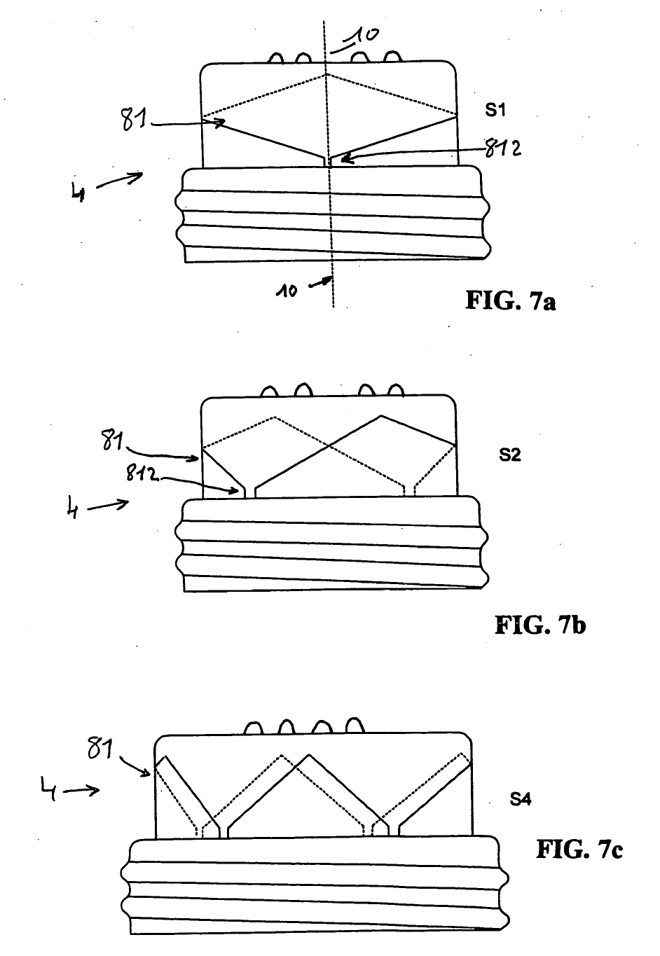

The other variants in FIG. 5 correspond to order N symmetries where N varies from 2 to 4. Furthermore, as already mentioned, FIG. 2b shows the case of a symmetry S₅, FIGS. 6a and 6b show the case of a symmetry S₃, FIG. 7a shows the case of a symmetry S₁, FIG. 7b shows the case of a symmetry S₂, and FIG. 7c shows the case of a symmetry S₄.

As shown particularly in FIGS. 6a and 6b, the said orientation means (8) may include cooperation of a male axial element (80) and a female axial element (81) capable of cooperating during the said screwing, the said male element (80, 44, 74) being carried by a skirt (46) of the said head (4) or by a sidewall (76) of the said insert (7), the said female element (81, 45, 75) then being carried by a sidewall (76) of the said insert (7) or by the said skirt (46) of the said head (4).

Typically, the said male element (80, 44, 74) may comprise N typically vertical edges or radial projections (80′), and the said female element (81, 45, 75) comprises N “V-shaped” or funnel shaped ramps or profiles (810) with a tip (811) forming or including a typically vertical or axial groove or channel (812) such that during the said screwing, each radial edge or projection (80′) being guided by a ramp (810), one end (800) of the said axial edge or projection (80′) being guided towards the said tip (811) or the said axial channel (812), the said insert (7) is firstly oriented automatically with respect to the said head (4), and then the said single axial projection (72) closes off the said single orifice (42) or the said n axial projections (73) close off the said n orifices (43).

Thus, the same number N relates simultaneously to:
the order symmetry of he orifice (41, 42, 42) and the corresponding axial projection (71, 72, 73) that will close off the said orifice,
the number of edges or radial projections (80′) forming all or part of the said male axial element (80),
the number of “V-shaped” ramps or profiles (810) forming all or part of the said female element (81).

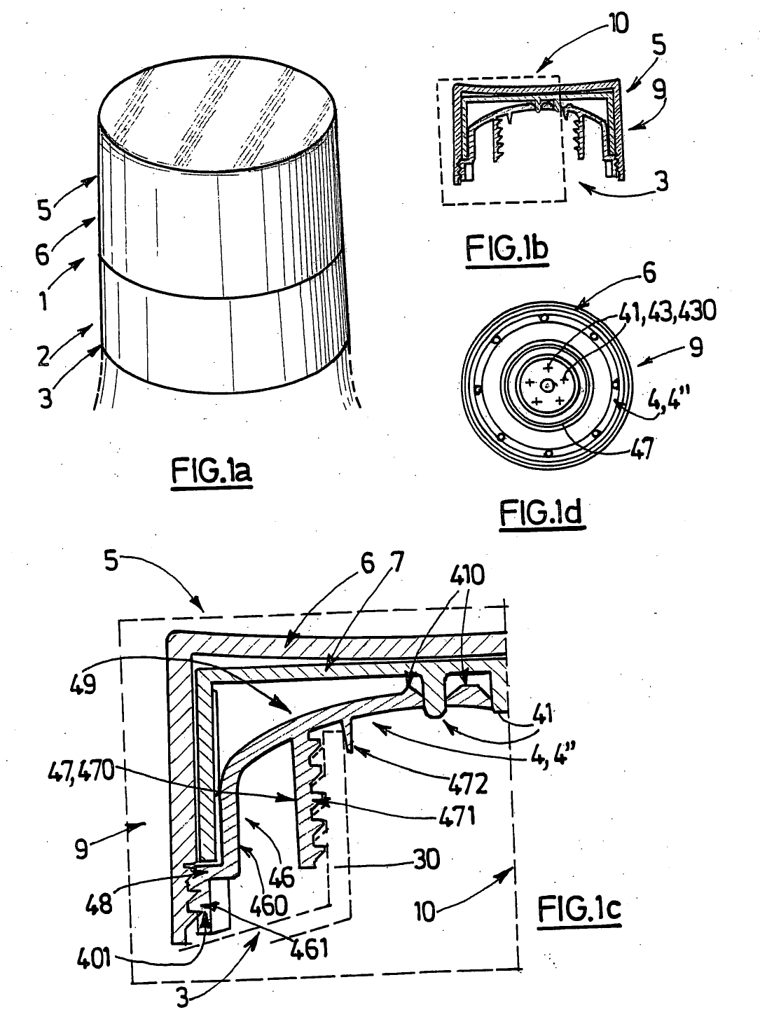

As shown in FIG. 6a, and also in FIGS. 1c, 2b, 3a, 4b, the said female element (81) may be carried by the said skirt (46) of the said head (4), the said tip (811) or the said channel (812) then being located on the lower part of the said female element (81).

Conversely, and as shown in FIG. 6b, the said female element (81) may be carried by the said sidewall (76) of the said insert (7), the said tip (811) or the said channel (812) then being located on the said upper part of the said female element (81).

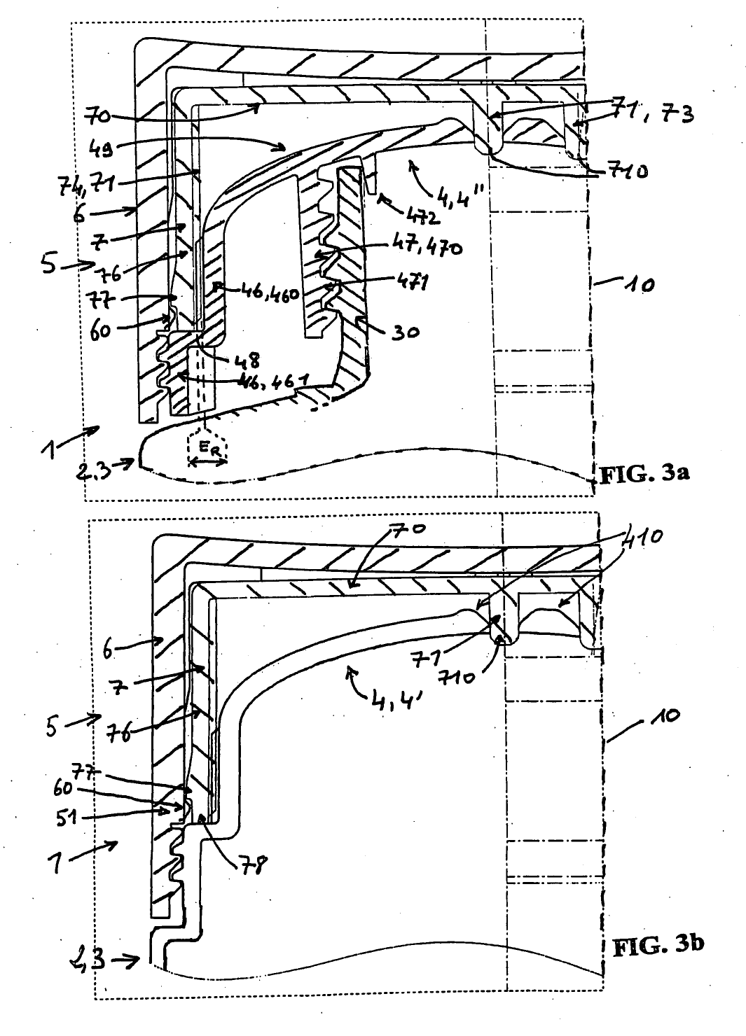

As shown in FIG. 3b, the said head (4) may form a single piece part (4′) with the said body (3), the said receptacle (2) typically forming a tube that can be filled through the bottom. In this case, the dispenser-applicator (1) as shown in FIG. 3b is turned over and filled through the bottom, and the lower end of the skirt of the tube is then welded.

As shown for example in FIG. 3a, the said head (4) may form an independent part (4″) including a means (47) of fixing the said body (2) and the said head (4″), forming two distinct parts assembled together.

In this case, the said head (4″) may include an internal thread (471), typically carried by an inner wall (470) of the said head (4″) such that the said head (4″) may be fixed by screwing to any type of body (3) comprising a threaded neck (30), typically in a leak type manner due to a sealing lip (472).

In this case, the said independent part (4″), typically screwed to the said cap (5) but possibly click fitted, may be fixed to any type of receptacle provided with a neck, such as a tube, a flask or any other type of receptacle or similar receptacle body that can be filled through its neck (30) before the said independent part (4″) is screwed into place as a distribution head (4).

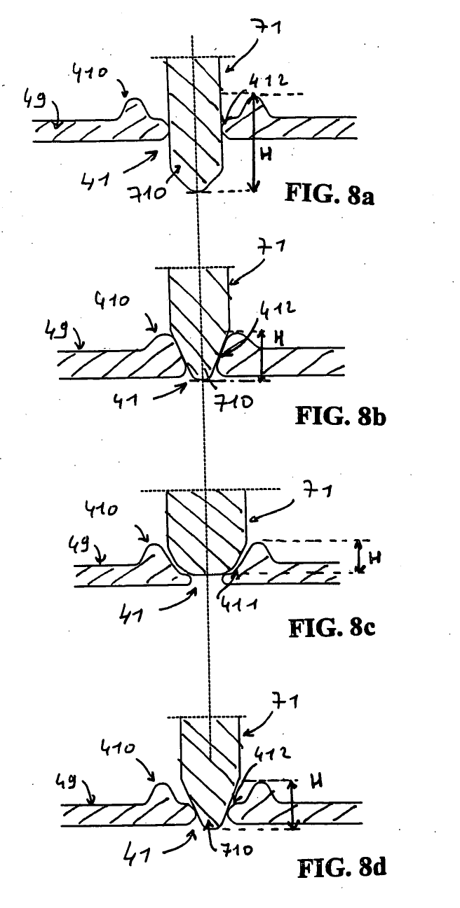

According to the invention and as shown particularly in FIGS. 3b and 8a to 8d, the said single orifice (42) or the said n orifices (43) may include an edge (410) typically forming a rim capable of performing a uniform distribution of the said product together with application of the said product particularly including a massage effect if the said product is a cosmetic or dermatological product to be applied on the skin.

As shown for example in FIG. 2b, or on the variants G, N, O, Q in FIG. 5, the said n orifices (43) may include a uniform spacing between the said n orifices, the said spacing being between 3 mm and 20 mm, the said individual orifices (430) among the said plurality of orifices (43) typically being circular. This spacing generally varies from 5 mm to 10 mm.

According to the invention, the number N can vary from 2 to 6. It is important that the slope of the said ramp (810) is sufficient so that the end (800) of the male axial element slides on the ramp (810) and makes the inner insert (7) turn as the shell (6) is screwed onto the head (4).

This slope will also depend on the diameter of the said head, that typically varies from 10 mm to 60 mm.

The said “V-shaped” or funnel shaped ramp or profile (810) then typically forms an angle α equal to 120°±30°.

Typically, the said single orifice (41) may have a square section, or it may be square with rounded corners, hexagonal, octagonal, or it may be in the form of a straight or curved longitudinal slit, or cross-shaped slits, the said single axial projection (71) having a corresponding complementary shape designed to close off the said single orifice (41).

Similarly, the said n orifices (42) may include one or several orifices with a round or square section, or square with rounded corners, hexagonal, octagonal, or it may be in the form of a straight or curved longitudinal slit, or cross-shaped slits, the said plurality of axial projections (71) having a corresponding complementary shape designed to close off the said n orifices (42).

As shown in FIG. 8c, the said single orifice (42) or the said plurality of orifices (43) may comprise an annular seating (411) forming a stop for the said axial projection (71) or for each axial projection (730) of the said n axial projections (73), such that the said screwing applies axial compression or tension between the said single axial projection (72) or the said n axial projections (73) and the said corresponding annular seating (411), the said axial compression or tension causing a sealed closure of the said single orifice (42) or the said plurality of orifices (43), thus enabling effortless unscrewing.

As shown in FIGS. 8a, 8b and 8d, the said single axial projection (72) or each of the said axial projections (730) of the said n axial projections (73) may include a lower end (710) penetrating into the said single orifice (42) or the said plurality of orifices (43), such that the said screwing introduces axial and/or radial compression or tension between the said single axial projection (72) or the said n axial projections (73) and the inner wall (412) of the said single orifice (42) or the said plurality of orifices (43), the said axial and/or radial compression or tension causing sealed closure of the said single orifice (42) or the said plurality of orifices (43), and allowing screwing/unscrewing with no particular effort.

As shown in FIGS. 8a to 8d, the said axial projection (71) penetrates into the said orifice (41) over a height H, through its lower end (710), the height H typically varying from 0.5 mm to 3 mm, which in particular enables elimination of any progressive blocking of the said orifice (41) with time, and achieves an excellent seal.

As shown in FIG. 3a, the said N edges or radial projections (80′) and the said N “V-shaped” or funnel shaped ramps or profiles (810) may have a sufficient radial thickness or depth to enable cooperation by a radial overlap over a radial distance E_{R}, typically varying from 0.1 mm to 2 mm.

As also shown in FIG. 3a, the said sealing insert (7) free to rotate with respect to the said outer shell (6), may typically be click fitted into the said outer shell (6) by cooperation of an inner radial groove of the said shell (60) and an outer radial groove (77) of the said inner insert (7). This type of cooperation forms an assembly that is easy to implement and that enables free rotation of the insert (7) in the shell (6), so that the insert can be oriented during screwing of the cap (5).

Typically, and as for example shown in FIG. 6a, the said head (4) may include a shoulder (48), typically at mid-height of the said skirt (46), delimiting an upper portion (460) of the said skirt and a lower portion (461) of the said skirt (46), the said upper portion (460) carrying the said male element (44) or female element (45) forming the said male element (80) or female element (81) respectively of the said orientation means, the said lower portion (461) carrying the said outer thread (40).

The said shoulder (49) may be axially facing the sidewall (76) of the said insert (81), and may have a radial width equal to at least the radial overlap E_{R} between the said male axial element (80) and the said female element (81).

According to the invention, at least the said head (4, 4′, 4″) and the said inner insert (7) may be moulded thermoplastic parts.

Another purpose of the invention is composed of an element (9) of a dispenser-assembler (1) according to the invention including the combination of the said head (4) forming an independent part (4″) and the said cap (5), fixed by screwing to the said cap (5), the said assembly (9) being designed to be fixed to a receptacle body (3) with a flexible wall, typically a tube, typically by screwing.

Such an element is shown in FIG. 1c.

### Example Embodiments

All FIGS. 1a to 8d show example embodiments.

1—FIGS. 1a to 2b, 3a, 4a and 4b relate to a first embodiment of dispensers-applicators (1) according to the invention in which the distribution head (4) forms an independent part (4″) separate from the body (3), while FIG. 3b describes a second embodiment according to which the distribution head (4) forms a single-piece part with the body (3).

The dispenser-applicator (1) in FIG. 1a comprises a receptacle (2) with a flexible wall, typically a tube, only part of which was shown, the said receptacle (2) that includes a body (3) containing the product to be distributed, being closed by a screwed cap (5). In this FIG. 1a, the shell (6) of the cap conceals the insert (7) and the head (4) fixed by screwing to the body (3) as shown in FIGS. 1b and 1c.

The dashed lines in FIG. 1a diagrammatically show the extension of the receptacle (2) or the body (3), typically the tube forming the said receptacle (2) or the said body (3).

FIG. 1b shows the said cap (5) and the said distribution head (4), these two screwed parts forming an assembly (9) that can be screwed onto any receptacle (2) comprising a body (3) and a threaded neck (30).

FIG. 1c is an enlarged partial view of FIG. 1b showing the neck (30) of the body (3) in dashed lines.

FIG. 1d is a bottom view of the said assembly (9).

2—FIGS. 2a and 2b show the said cap (5) separated from the said head (4, 4″).

The said head (4, 4″) comprises a rounded top (49), in this case forming a curved arch, and an axial skirt (46).

The said rounded top (49) carries six circular orifices (430) instead of the single orifice (41), each provided with a peripheral rim (410) designed to massage the skin during application of the product. This plurality of orifices (43) comprises a central orifice surrounded by five orifices forming a regular pentagon, such that the said plurality of orifices (43) has an order 5 symmetry of rotation denoted S₅, in which a rotation of 360°/5 with respect to the said axial direction (10) reproduces the same figure or arrangement of orifices (430).

The said axial skirt (46) comprises a shoulder (48) separating an upper part (460) of the said skirt (46) from a lower part (461), the said upper part (460) carrying a sequence of 5 “V-shaped” ramps for which the lower tip (811) located close to the said shoulder (48) forms an axial groove (812). This sequence of five ramps (810) that has the same symmetry S₅ as the said plurality of orifices (43), forms the female element (81) of the said orientation means (8). The lower part (461) of the said skirt (46) carries the outer thread (40).

3—FIGS. 3a and 3b illustrate two typical embodiments of the invention; in FIG. 3a, according to a first embodiment, the said distribution head (4) forms an independent part (4″) separate from the body (3), while in FIG. 3b, according to a second embodiment, the said distribution head (4) forms a single piece part (4′) with the body (3), this assembly typically forming a tube open at its bottom so that it can be filled.

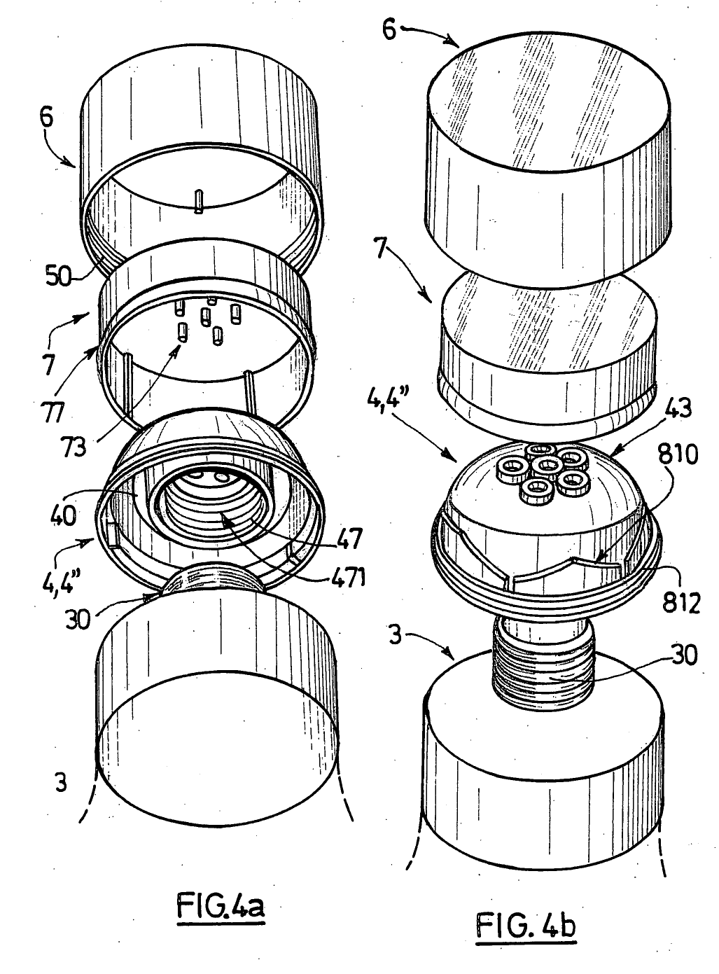

4—FIGS. 4a and 4b illustrate the said first embodiment in FIG. 3a, the different parts forming the dispenser-applicator (1) being shown separately from each other and comprising, starting from the top and working downwards, the shell (6), the inner insert (7), the distribution head (4, 4″), the upper portion of the tube body (3) comprising a shoulder and a central neck (30).

5—FIG. 5 diagrammatically shows 20 orifice variants (41) marked from A to T, in the form of a single orifice (42) or a plurality of orifices (43), and the corresponding axial projection variants (71) that will close off the said orifice (41), in the form of a single axial projection (72) or a plurality of axial projections (73).

The orifices (41) and corresponding axial projections (71) have symmetries of rotation as follows:
order 1 symmetry (S₁) for variants A, B, F, G, H, J, P, R and T,
order 2 symmetry (S₂) for variants E, L, M, N, Q and S,
order 3 symmetry (S₃) for variants C, I and K,
order 4 symmetry (S₄) for variants D and O.

The number n of orifices is:
1 for variants A, E, F, I, L, M and S
2 for B and T,
3 for C, K and N,
4 for D, J, Q and R,
5 for G,
8 for H,
12 for P.

6—FIGS. 6a and 6b illustrate different embodiments of the orientation means (8), in diagrammatic side views of the male element (80) and female element (81) that cooperate with each other when the said cap (5) is being screwed onto the distribution head (4):
in FIG. 6a, as in FIG. 2b, the skirt (46) of the distribution head (4) carries the female element (81) in the form of three adjacent ramps with a “V-shaped” profile (810), for which the lower tip (811) forms an axial groove (812) while the inner insert (7) of the cap (5) carries three axial projections (71) forming the male axial element (8), the projections (71) being oriented at 360°/3 so as to automatically orient an axial projection (71, 72, 73) with respect to an orifice (41, 42, 43) with the same order 3 symmetry of rotation (S₃).
FIG. 6b shows the inverse case of the previous case; the inner insert (7) of the cap (5) carries the female element (81) in the form of three adjacent ramps with a “V-shaped” profile (810), while the skirt (46) carries three axial projections (71) forming the male axial element (8).

In both of these two Figures, the cap (5) and its insert (7) have been shown in dashed lines above the said distribution head (4), the male element (80) and the female element (81) of the said orientation means (8) being shown facing each other before orientation.

7—FIGS. 7a to 7c diagrammatically show the head (4) in FIG. 6a fitted with the said female element (81) with the ramps (810) of the orientation means (8), and illustrate several orders of symmetries:
FIG. 7a shows the case of a symmetry of rotation S₁ with a single ramp (810) within 360°, which can be used in the case of a small diameter head so that the slope of the said ramp (810) is sufficiently steep so that the male axial element (80) is free to slide,
FIG. 7b shows the case of symmetry of rotation S₂ with two ramps (810) within 360°,
FIG. 7c shows the case of symmetry of rotation S₄ with four ramps (810) within 360°.

It should be noted that FIG. 6a shows the case of symmetry of rotation S₃, and FIG. 2b shows the case of symmetry of rotation S₅.

8—FIGS. 8a to 8d illustrate different embodiments of closing an orifice (41, 42, 43, 430) by the said axial projection (71, 72, 73, 730).
FIG. 8a shows an embodiment of FIG. 3a; the axial projection (71) is cylindrical and its rounded lower end (710) closes off the annular inner edge (413) of the orifice (41),
FIG. 8b corresponds to the case in which the lower end (710) of the axial projection is tapered and the orifice (41) has a tapered inner surface (412),
FIG. 8c corresponds to the case in which the orifice (41) forms an annular seating (411) and in which the lower end (710) forms a rounded end matching the shape of the said seating,
FIG. 8d corresponds to the case in which the orifice is similar to that in FIG. 8a, while the axial projection (71) is similar to that in FIG. 8b.

In these figures, the axial height H corresponding to the axial cooperation between the said orifice (41) and the said axial projection (71) are shown, this height H typically corresponding to the height of the said axial groove (812) enabling final axial displacement of the insert (7) sealing the said orifice (41), at the end of the cap screwing movement.

50 mm diameter caps were made.

Assemblies (9) with the same 50 mm diameter and 29.5 mm high were made, corresponding to the outside dimensions of the said shell (6), according to the embodiment shown in FIG. 3a or FIG. 3b.

The body (3) of the receptacle (2) was made using tubes and flasks with flexible walls.

Many variant orifices (41, 42, 43) were made as shown in FIG. 5.

For a system with order 1 symmetry S₁, the head diameter should be smaller than it would be if the symmetry were higher, to maintain a sufficient slope to the ramp (810).

Regardless of the variants or embodiments of the invention, the applicant has observed that it is easy to close off these orifices with the means according to the invention, such that they are always leak tight in the long term, without any risk of these orifices becoming progressively blocked.

It has been observed that directly closing each orifice makes it possible to have a head in which there are relatively few leaks of the packaged product.

It has been observed that the seal obtained by axial penetration of the said axial projection (71) in all or part of the said orifice (41) enables a cap opening and closing force (5) that varies little in the long term, and that is relatively small considering the excellent seal obtained.

Furthermore, the presence of rims (410) on the rounded top (49) of the said head (4), and particularly around the orifices, enables application of the packaged product accompanied by massage of the said support, and typically the skin when the said product is a cosmetic or dermatological product.

List of marks

| | |
|---|---|
| Dispenser - applicator | 1 |
| Axial direction | 10 |
| Receptacle of 1 | 2 |
| Body of 2 | 3 |
| Threaded neck of 3 | 30 |
| Distribution head of 2 | 4 |
| Head as single-piece part with 3 | 4′ |
| Head as independent part distinct from 3 | 4″ |
| Outer thread | 40 |
| Orifice | 41 |
| Edge of 41, 42, 43 forming rim | 410 |
| Annular seating of 41, 42, 43 | 411 |
| Inner wall | 412 |
| Single orifice | 42 |
| A plurality of orifices | 43 |
| Individual orifice | 430 |
| Male element of 8, 80 | 44 |
| Female element of 8, 81 | 45 |
| Skirt of 4 carrying 44 or 45 | 46 |
| Upper portion | 460 |
| Lower portion | 461 |
| Means of fixing 4″ to 3 | 47 |
| Inner wall | 470 |
| Internal thread | 471 |
| Sealing lip | 472 |
| Shoulder | 48 |
| Rounded top of 4 carrying 41, 42, 43 | 49 |
| Cap of 1 | 5 |
| Internal thread | 50 |
| Means of fixing 6 and 7 | 51 |
| Outer shell of 5 | 6 |
| Radial fixing rib of 7 | 60 |
| Inner insert of 5 | 6 |
| Bottom of 7 | 70 |
| Axial projection | 71 |
| Lower end of 71, 72, 73 | 710 |
| Single axial projection | 72 |
| A plurality of axial projections | 73 |
| Individual axial projection | 730 |
| Male element of 8, 80 | 74 |
| Female element of 8, 81 | 75 |
| Sidewall carrying 74 or 75 | 76 |
| Radial fixing rib of 6 | 77 |
| Lower end of 7 | 78 |
| Orientation means of 5, 7 with respect to 4 | 8 |
| Male axial element | 80 |
| End | 800 |
| Radial projection | 80′ |
| Female element | 81 |
| Ramp - “V-shaped” profile | 810 |
| Tip | 811 |
| Axial groove or channel | 812 |
| Element of 1 formed by 4″ + 5 | 9 |

1. Dispenser-applicator (1) of a fluid or powder product, typically a cosmetic product, onto a support, typically the skin, comprising a receptacle (2) that will contain the said product, formed from a body (3) and a threaded distribution head (4), provided with at least one orifice (41), and a threaded cap (5) that will close the said head (4), the said cap (5) typically comprising an internal thread (50) and the said head (4) typically comprising an external thread (40), the said internal thread (50) and external thread (40) cooperating such that the said cap (5) can close the said head by screwing along an axial screwing direction (10), characterised in that:
a) the said orifice (41) forms or comprises a single orifice (42) or n orifices (43), the said single orifice (42) or the said n orifices (43) not having any symmetry of revolution with respect to the said axial direction (10),
b) the said cap (5) comprises an outer shell (6) carrying the said internal thread (50) and an inner sealing insert (7), the said inner insert (7) being free to move in rotation along the said axial direction (10) with respect to the said outer shell (6),
c) the said inner insert (7) comprises a bottom (70) carrying an axial projection (71) forming a single axial projection (72) capable of closing off the said single orifice (42), or n axial projections (73) capable of closing off the said n orifices (43), the said single axial projection (72) or the said n axial projections (73) typically forming a sealing pin (72′) or n sealing pins (73′), the said sealing pin (72′) or the said n sealing pins (73′) having a section matching the section of the said single orifice or the said n orifices, such that the said sealing pin (72′) or the said n sealing pins (73′) are capable of closing off the said single orifice or the said n orifices, typically by axial penetration at the end of screwing,
d) the said insert (7) and the said head (4) cooperate during the said screwing due to an orientation means (8), firstly so as to automatically orient the said insert (7) with respect to the said head (4) during screwing of the said cap (5) onto the said head (4) by relative manual rotation of the said outer shell (6), so that the said single axial projection (72) or the said n axial projections (73) face the said single orifice (42) or the said n orifices (43), then typically displace the said axial insert with respect to the said head in order to close off the said orifice.

2. Dispenser-applicator according to claim 1, in which the said orifice (41) is formed of the said single orifice (42).

3. Dispenser-applicator according to claim 1, in which the said orifice (41) is formed of the said n orifices (43), where n varies from 2 to 12.

4. Dispenser-applicator according to claim 1, in which the said single orifice (42) or the said n orifices (43) have a symmetry of rotation S_{N} with respect to the said axial screwing direction (10), where N typically varies from 1 to 8, a symmetry of rotation S_{N} denoting identity of the object by rotation of 360°/N.

5. Dispenser-applicator according to claim 1, in which the said orientation means (8) includes cooperation of a male axial element (80) and a female axial element (81) capable of cooperating during the said screwing, the said male element (80, 44, 74) being carried by a skirt (46) of the said head (4) or by a sidewall (76) of the said insert (7), the said female element (81, 45, 75) then being carried by a sidewall (76) of the said insert (7) or by the said skirt (46) of the said head (4).

6. Dispenser-applicator according to claim 5, in which the said male element (80, 44, 74) comprises N typically vertical edges or radial projections (80′), and in which the said female element (81, 45, 75) comprises N “V-shaped” or funnel shaped ramps or profiles (810) with a tip (811) forming or including a typically vertical or axial groove or channel (812) such that during the said screwing, each radial edge or projection (80′) being guided by a ramp (810), one end (800) of the said radial edge or projection (80′) being guided towards the said tip (811) or the said axial channel (812), the said insert (7) is firstly oriented automatically with respect to the said head (4), and then the said single axial projection (72) closes off the said single orifice (42) or the said n axial projections (73) close off the said n orifices (43).

7. Dispenser-applicator according to claim 6, in which the said female element (81) is carried by the said skirt (46) of the said head (4), the said tip (811) or the said groove or channel (812) then being located on the lower part of the said female element (81).

8. Dispenser-applicator according to claim 6, in which the said female element (81) is carried by the said sidewall (76) of the said insert (7), the said tip (811) or the said channel (812) then being located on the said upper part of the said female element (81).

9. Dispenser-applicator according to claim 1, in which the said head (4) forms a single piece part (4′) with the said body (3), the said receptacle (2) typically forming a tube that can be filled through the bottom.

10. Dispenser-applicator according to claim 1, in which the said head (4) forms an independent part (4″) including a means (47) of fixing the said body (2) and the said head (4″), forming two distinct parts assembled together.

11. Dispenser-applicator according to claim 10, in which the said head (4″) includes an internal thread (471), typically carried by an inner wall (470) of the said head (4″) such that the said head (4″) may be fixed by screwing to any type of body (3) comprising a threaded neck (30), typically in a leak type manner due to a sealing lip (472).

12. Dispenser-applicator according to claim 1, in which the said single orifice (42) or the said n orifices (43) includes an edge (410) typically forming a rim capable of applying the said product with a massage effect.

13. Dispenser-applicator according to claim 1, in which the said n orifices (43) include a uniform spacing between the said n orifices, the said spacing being between 3 mm and 20 mm, the said orifices (430) among the said plurality of orifices (43) typically being circular.

14. Dispenser-applicator according to claim 4, in which the number N varies from 2 to 6.

15. Dispenser-applicator according to claim 6, in which the said “V-shaped” or funnel shaped ramp or profile (810) typically forms an angle α equal to 120°±30°.

16. Dispenser-applicator according to claim 1, in which the said single orifice (41) has a square section, or square with rounded corners, hexagonal, octagonal, or in the form of a straight or curved longitudinal slit, or cross-shaped slits, the said single axial projection (71) having a corresponding complimentary shape designed to close off the said single orifice (41).

17. Dispenser-applicator according to claim 1, in which the said n orifices (42) includes one or several orifices with a round or square section, or square with rounded corners, hexagonal, octagonal, or in the form of a straight or curved longitudinal slit, or cross-shaped slits, the said plurality of axial projections (72) having a corresponding complementary shape designed to close off the said n orifices (42).

18. Dispenser-applicator according to claim 1, in which the said single orifice (42) or the said plurality of orifices (43) may comprise an annular seating (411) forming a stop for the said axial projection (71) or for each axial projection (73) of the said n axial projections (73), such that the said screwing applies axial and/or radial compression or tension between the said single axial projection (72) or the said plurality of n axial projections (73) and the said corresponding annular seating (411), the said axial and/or radial compression or tension causing a sealed closure of the said single orifice (42) or the said plurality of orifices (43), and allowing screwing/unscrewing with no particular effort.

19. Dispenser-applicator according to claim 1, in which the said single axial projection (72) or each of the said axial projections (730) of the said n axial projections (73) includes a lower end (710) penetrating into the said single orifice (42) or the said plurality of orifices (43), such that the said screwing introduces axial compression or tension between the said single axial projection (72) or the said n axial projections (73) and the inner wall (412) of the said single orifice (42) or the said plurality of orifices (43), the said axial compression or tension causing sealed closure of the said single orifice (42) or the said plurality of orifices (43), and also allowing unscrewing with no particular effort.

20. Dispenser-applicator according to claim 6, in which the said N edges or radial projections (80′) and the said N “V-shaped” or funnel shaped ramps or profiles (810) have a sufficient radial thickness or depth to enable cooperation by a radial overlap over a radial distance E_{R}, typically varying from 0.1 mm to 2 mm.

21. Dispenser-applicator according to claim 1, in which the said sealing insert (7) free to rotate with respect to the said outer shell (6), is typically click fitted into the said outer shell (6) by cooperation of an inner radial groove of the said shell (60) and an outer radial groove (77) of the said inner insert (7).

22. Dispenser-applicator according to claim 1, in which the said head (4) includes a shoulder (48), typically at mid-height of the said skirt (46), delimiting an upper portion (460) of the said skirt and a lower portion (461) of the said skirt (46), the said upper portion (460) carrying the said male element (44) or female element (45) forming the said male element (80) or female element (81) respectively of the said orientation means (8), the said lower portion (461) carrying the said outer thread (40).

23. Dispenser-applicator according to claim 22, in which the said shoulder (49) is axially facing the sidewall (76) of the said insert (81), and has a radial width equal to at least the radial overlap E_{R} between the said male axial element (80) and the said female element (81).

24. Dispenser-applicator according to claim 1, in which at least the said head (4, 4′, 4″) and the said inner insert (7) are moulded thermoplastic parts.

25. Element (9) of a dispenser-applicator according to claim 10, including the combination of the said head (4) forming a independent part (4″) and the said cap (5), fixed by screwing to the said cap (5), the said assembly (9) being designed to be fixed to a receptacle body (3) with a flexible wall, typically a tube, typically by screwing.
